(19) United States
(12) Patent Application Publication
(10) Pub. No.: US 2013/0246116 A1
(43) Pub. Date: Sep. 19, 2013

(54) ASSISTING USER TO SCHEDULE A MEETING WITH THE BEST CANDIDATE FROM A LIST OF INDIVIDUALS BASED ON PAST COMMUNICATION HISTORY, CALENDAR INFORMATION AND USER'S RULES

(71) Applicants: Judith H. Bank, Morrisville, NC (US); Lisa M. Bradley, Cary, NC (US); Lin Sun, Morrisville, NC (US); ChunHui Yang, Durham, NC (US)

(72) Inventors: Judith H. Bank, Morrisville, NC (US); Lisa M. Bradley, Cary, NC (US); Lin Sun, Morrisville, NC (US); ChunHui Yang, Durham, NC (US)

(73) Assignee: INTERNATIONAL BUSINESS MACHINES CORPORATION, Armonk, NY (US)

(21) Appl. No.: 13/422,392

(22) Filed: Mar. 16, 2012

(51) Int. Cl. G06Q 10/10

(52) U.S. Cl. 705/7.19

(57) ABSTRACT

A method, system and computer program product for scheduling a meeting with the best candidate(s). The user requests to schedule a meeting during a selected period of time. The system receives a set of rules concerning the scheduling of the meeting. Additionally, the system searches a past communication history (a past communication pattern) between the user and the individual(s) listed in a list of possible candidates. Furthermore, the system searches the calendar application for the individual(s) listed in the list to obtain scheduling information. The past communication history, calendar information and user's rules are analyzed with respect to the individual(s) listed in the list. Based on this analysis, a person deemed to be the best candidate is selected to receive a meeting invitation from the user to attend the meeting requested by the user during the selected period of time.

### TECHNICAL FIELD

The present invention relates to calendaring systems, and more particularly to assisting the user to schedule a meeting with the best candidate(s) selected from a list of individuals based on past communication history, calendar information and user's rules.

### BACKGROUND

Calendaring systems maintain a number of scheduled events to help users manage their time. Many calendaring systems are collaborative, which permit a sharing of calendar events, such as meetings, among a set of meeting participants.

However, calendaring systems are limited in their functionality. By way of example, calendaring systems do not currently assist the user in selecting the individual(s) who are the best candidates to have a meeting with the user. For example, if a user realizes at the last minute that he/she is available for lunch and can have lunch with a friend/co-worker, then the user currently has to e-mail/ping one person at a time (where each person is personally selected by the user) to determine if that person is available to have lunch with the user. If the first person the user pings/e-mails is not available to have lunch, then the user will have to continue to ping/e-mail others until the user has set-up a lunch appointment with a friend/co-worker.

Such a process is inefficient and time consuming in identifying available or appropriate individuals to have a meeting with the user, such as a last-minute meeting with the user.

### BRIEF SUMMARY

In one embodiment of the present invention, a method for scheduling a meeting with one or more best candidates comprises receiving a request from a user to schedule a meeting during a selected period of time. The method further comprises receiving a list of individuals. The method additionally comprises receiving rules concerning scheduling the meeting. Furthermore, the method comprises searching a past communication history between the user and one or more persons from the list of individuals. Additionally, the method comprises searching a calendar application for the one or more persons listed in the list of individuals to obtain scheduling information. In addition, the method comprises analyzing the past communication history, the calendar information and the rules. The method further comprises issuing, by a processor, a first meeting invitation to a first person from the one or more persons listed in the list of individuals to participate in the meeting with the user during the selected period of time based on the analysis.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may be used to form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates a calendaring system configured in accordance with an embodiment of the present invention;

FIG. 2 illustrates a hardware configuration of a client system in accordance with an embodiment of the present invention; and

FIGS. 3A-3B are a flowchart of a method for scheduling a meeting with the best candidate(s) selected from a list of individuals based on the past communication history, calendar information and user's rules in accordance with an embodiment of the present invention.

### DETAILED DESCRIPTION

The present invention comprises a method, system and computer program product for scheduling a meeting with the best candidate(s). In one embodiment of the present invention, the user requests to schedule a meeting, such as a last minute meeting, during a selected period of time (e.g., 12:30 pm-1:30 pm). The system receives a set of rules concerning the scheduling of the meeting. These rules are used by the system to determine which individual out of a list of possible candidates should be selected to have a meeting with the user. Rules, as used herein, refer to the requirements or settings established by the user in connection with the meeting to be held. Additionally, the system searches a past communication history (a past communication pattern) between the user and the individual(s) listed in the list. For example, the communications, such as e-mails, instant messages, phone calls, business meetings, etc., between the user and individual in question will be analyzed. Furthermore, the system searches the calendar application for the individual(s) listed in the list to obtain scheduling information, such as whether they have that time (the time of the meeting requested by the user) free on their schedule, “presence information,” relating to the physical location of the individuals, such as whether they are working from home, whether they have that time blocked off and so forth. Such scheduling information may be used to determine if there is a scheduling conflict or whether it would be feasible to schedule a meeting with such an individual. The past communication history, calendar information and user's rules are analyzed with respect to the individual(s) listed in the list. Based on this analysis, a person deemed to be the best candidate is selected to receive a meeting invitation from the user to attend the meeting requested by the user during the selected period of time. In this manner, a meeting (e.g., lunch appointment) may be scheduled with the best possible candidate without having the user take proactive action in identifying available or appropriate individuals to have a meeting with the user.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

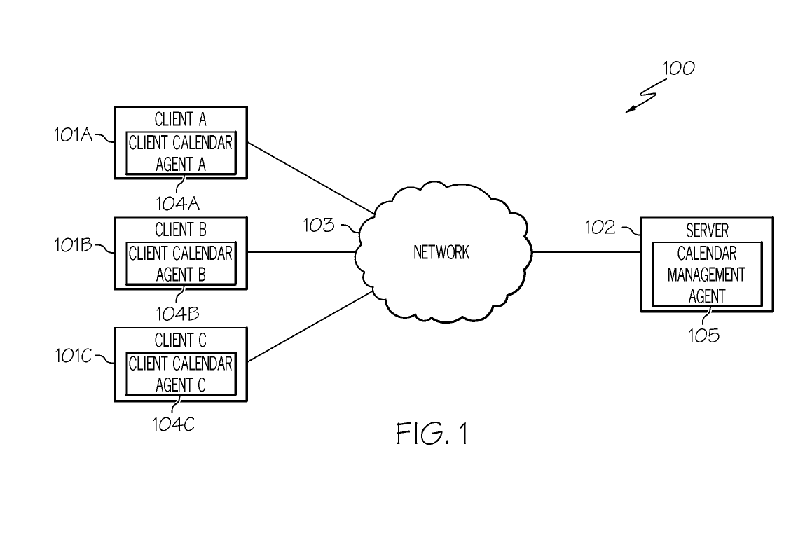

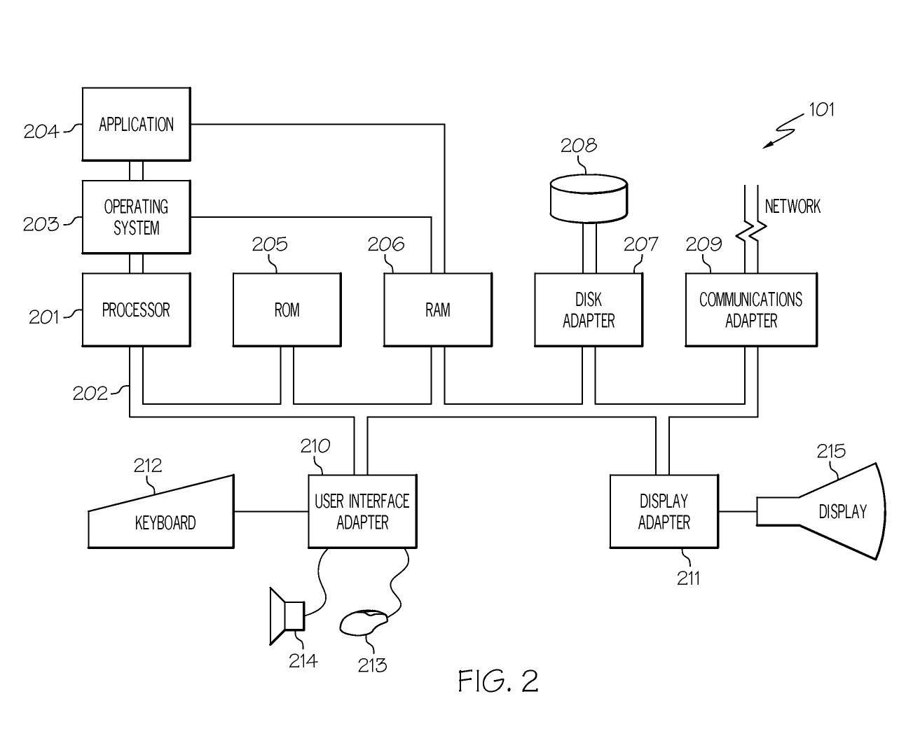

Referring now to the Figures in detail, FIG. 1 illustrates a calendaring system 100 for practicing the principles of the present invention in accordance with an embodiment of the present invention. Calendaring system 100 includes client systems 101A-101C (identified as “Client A,” “Client B,” and “Client C,” respectively, in FIG. 1) connected to a server 102 via a network 103. Clients 101A-101C may collectively or individually be referred to as clients 101 or client 101, respectively. Client 101 may be any type of computing device (e.g., portable computing unit, personal digital assistant (PDA), smartphone, laptop computer, mobile phone, navigation device, game console, desktop computer system, workstation, Internet appliance and the like) configured with the capability of connecting to network 103 and consequently communicating with other clients 101 and server 102. Each client 101 is configured to send out calendar appointments or meeting notices/invitations to other clients 101 using a calendar application via network 103. Any user of client 101 may be the creator or initiator of a meeting invitation and any user of client 101 may be a recipient of a meeting invitation. A description of the hardware configuration of client 101 is provided below in connection with FIG. 2.

Network 103 may be, for example, a local area network, a wide area network, a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention.

In calendaring system 100, clients 101A-101C include a software agent, referred to herein as a client calendar agent 104A-104C, respectively (identified as “Client Calendar Agent A,” “Client Calendar Agent B,” and “Client Calendar Agent C,” respectively, in FIG. 1). Client calendar agents 104A-104C may collectively or individually be referred to as client calendar agents 104 or client calendar agent 104, respectively. Furthermore, sever 102 includes a software agent, referred to herein as the calendar management agent 105. Calendar management agent 105 interfaces with client calendar agent 104 to present meeting invitations to clients 101. Client calendar agent 104 is configured to display the received meeting invitation as well as display calendar schedule information on the client's 101 calendar user interface.

While FIG. 1 illustrates three clients 101A-101C and a single server 102, calendaring system 100 may include any number of clients 101 and servers 102. The embodiments of calendaring system 100 are not to be limited in scope to the depiction of FIG. 1.

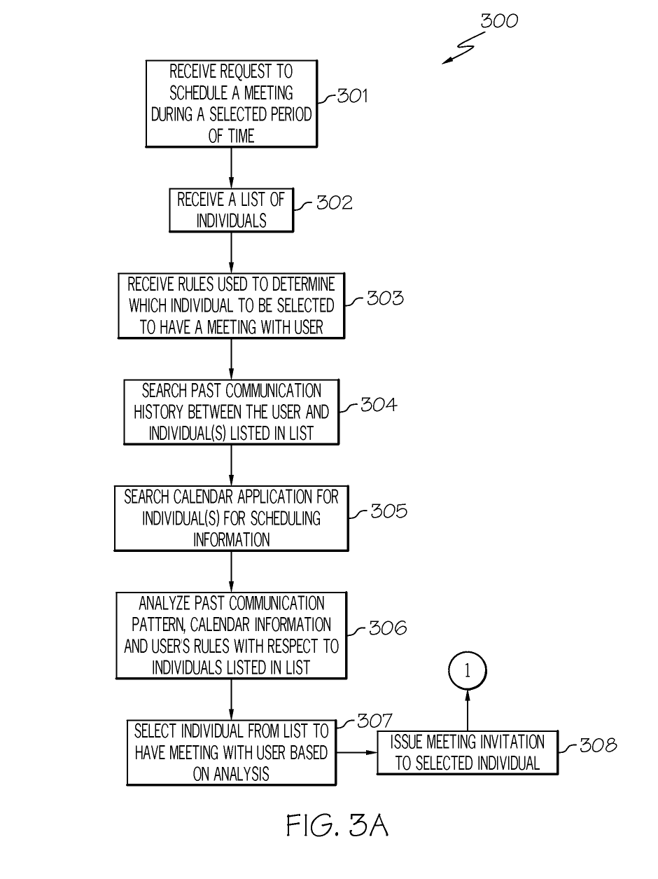

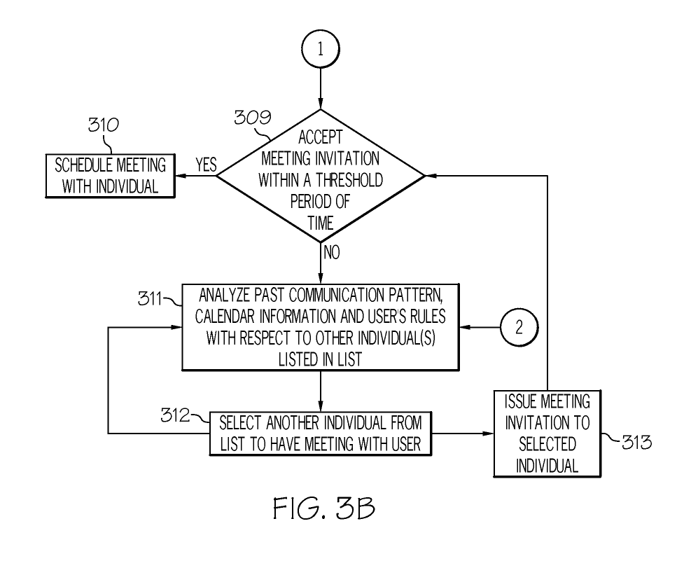

Referring now to FIG. 2, FIG. 2 illustrates a hardware configuration of client 101 (FIG. 1) which is representative of a hardware environment for practicing the present invention. Referring to FIG. 2, client 101 has a processor 201 coupled to various other components by system bus 202. An operating system 203 runs on processor 201 and provides control and coordinates the functions of the various components of FIG. 2. An application 204 in accordance with the principles of the present invention runs in conjunction with operating system 203 and provides calls to operating system 203 where the calls implement the various functions or services to be performed by application 204. Application 204 may include, for example, calendar agent 104 (FIG. 1) which may include the functionality for scheduling a meeting with the best candidate(s) selected from a list of individuals based on past communication history, calendar information and user's rules as discussed further below in association with FIGS. 3A-3B.

Referring again to FIG. 2, read-only memory (“ROM”) 205 is coupled to system bus 202 and includes a basic input/output system (“BIOS”) that controls certain basic functions of client 101. Random access memory (“RAM”) 206 and disk adapter 207 are also coupled to system bus 202. It should be noted that software components including operating system 203 and application 204 may be loaded into RAM 206, which may be client's 101 main memory for execution. Disk adapter 207 may be an integrated drive electronics (“IDE”) adapter that communicates with a disk unit 208, e.g., disk drive. It is noted that the program for scheduling a meeting with the best candidate(s) selected from a list of individuals based on past communication history, calendar information and user's rules, as discussed further below in association with FIGS. 3A-3B, may reside in disk unit 208 or in application 204.

Client 101 may further include a communications adapter 209 coupled to bus 202. Communications adapter 209 interconnects bus 202 with an outside network (network 103) thereby enabling client 101 to communicate with other clients 101 and server 102.

I/O devices may also be connected to client 101 via a user interface adapter 210 and a display adapter 211. Keyboard 212, mouse 213 and speaker 214 may all be interconnected to bus 202 through user interface adapter 210. A display monitor 215 may be connected to system bus 202 by display adapter 211. In this manner, a user is capable of inputting to client 101 through keyboard 212 or mouse 213 and receiving output from client 101 via display 215 or speaker 214.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

As stated in the Background section, calendaring systems are limited in their functionality. By way of example, calendaring systems do not currently assist the user in selecting the individual(s) who are the best candidates to have a meeting with the user. For example, if a user realizes at the last minute that he/she is available for lunch and can have lunch with a friend/co-worker, then the user currently has to e-mail/ping one person at a time (where each person is personally selected by the user) to determine if that person is available to have lunch with the user. If the first person the user pings/e-mails is not available to have lunch, then the user will have to continue ping/e-mail others until the user has set-up a lunch appointment with a friend/co-worker. Such a process is inefficient and time consuming in identifying available or appropriate individuals to have a meeting with the user, such as a last-minute meeting with the user.

The principles of the present invention provide a means for assisting the user to schedule a meeting (e.g., lunch appointment) with the appropriate individual without having the user take proactive action in determining if each potential person is available to make the meeting as discussed further below in FIGS. 3A-3B. FIGS. 3A-3B are a flowchart of a method for scheduling a meeting with the best candidate(s) selected from a list of individuals based on past communication history, calendar information and user's rules.

As stated above, FIGS. 3A-3B are a flowchart of a method 300 for scheduling a meeting with the best candidate(s) selected from a list of individuals based on past communication history, calendar information and user's rules in accordance with an embodiment of the present invention. A meeting, as used herein, is to be broadly interpreted to include any type of assembly or gathering of two or more individuals at a particular time, that may include information exchange, whether for business or for personal purposes, such as a business meeting, lunch, a phone call, online chat, etc. While method 300 is discussed below in identifying a particular individual as being the best candidate to have a meeting with the user, the principles of the present invention may be applied to selecting multiple individuals (such as a group of individuals) who would be the best candidates to have a meeting (such as a group meeting) with the user. A person of ordinary skill in the art would be capable of applying the principles of the present invention to such implementations. Further, embodiments applying the principles of the present invention to such implementations would fall within the scope of the present invention.

Referring to FIG. 3A, in conjunction with FIGS. 1-2, in step 301, calendar agent 104 receives a request from the user to schedule a meeting during a selected period of time. For example, the user may request to schedule a lunch meeting with a co-worker on Tuesday from noon-1:00 pm. It is noted that such a meeting may need to be scheduled at the last minute or may be scheduled far in advance.

In step 302, calendar agent 104 receives a list of individuals from the user of client 101 as possible candidates to be considered in scheduling a meeting with the user. In one embodiment, once the list is provided, the list no longer needs to be provided each time it is used by calendar agent 104. In one embodiment, the individuals in the list are ordered based on a priority assigned by the user (priority the user has in scheduling a meeting with them) such that individuals assigned a higher priority are listed higher than those individuals assigned a lower priority. For example, the individual listed at the top of the list has been assigned the highest priority by the user. In one embodiment, this list of individuals may be populated by calendar agent 104 based on past communication history, where past communication history refers to a past communication pattern between the user of client 101 and the individual in question. For example, the communications, such as e-mails, instant messages, phone calls, business meetings, etc., between the user and individual in question will be analyzed. If the user is communicating with an individual every day, then that person may be assigned a high priority by calendar agent 104 and hence be listed towards the top of the list. Additionally, calendar agent 104 may be able to determine the type of relationship the user has with an individual, such as based on the content of the conversations. For example, if the conversations become more personable from casual work conversations, then the person may be more of a friend than a co-worker. This may be important to infer if the user decides to schedule a lunch appointment with a friend rather than a co-worker. In one embodiment, the list of individuals may initially be provided by the user of client 101 but then modified dynamically based on past communication history. In one embodiment, calendar agent 104 suggests to the user individuals to be added to this list of individual based on past communication history. In one embodiment, calendar agent 104 suggests to the user rankings of various individuals based on past communication history.

In step 303, calendar agent 104 receives rules from the user concerning scheduling a meeting. These rules are used by calendar agent 104 to determine which individual should be selected to have a meeting with the user as discussed further below. Rules, as used herein, refer to the requirements or settings established by the user in connection with a meeting to be held. For example, rules may include the frequency with which to meet a particular individual. For instance, the user may specify to meet with a particular individual at least once per week. In another example, the rules for a particular meeting (e.g., lunch) may be to set-up a lunch with a person the user has not had lunch with in a long time. Other examples include assigning individual(s) priorities in scheduling a meeting with the user. For example, a rule may be that person 1 is to be assigned the highest priority and person 4 is to be assigned the lowest priority. Furthermore, the rule may specify that a meeting is to first be attempted to be scheduled with person 1, who is assigned the highest priority and listed at the top of the list, and that person 4, who is assigned the lowest priority and listed at the bottom of the list, is to be the “person of last resort,” meaning that person 4 is only to be scheduled to have a meeting with the user if there are no other available individuals. Other exemplary rules include listing work friends prior to co-workers in the list of individuals to be considered in scheduling a meeting with the user, meeting with a designated individual at least x times per month or year (contact frequency), meeting with a designated individual more than once per week, only meeting with individuals from a designated group, etc. In another example, a rule could specify setting up a meeting with a personal friend rather than a co-worker. In a further example, a rule could specify setting up a meeting with those individuals who communicate the most with the user. In another example, a rule could specify setting up a meeting with those individuals who do social activities (e.g., going to the gym) with the user. In a further example, a rule could specify that person C is to attend a meeting, such as a group meeting, with the user only if person B is attending as well. These exemplary rules are for illustrative purposes and rules are not to be limited in scope to these examples. Rules include any requirements or settings that may be used in determining which individual is the best candidate for having a meeting with the user.

In step 304, calendar agent 104 searches the past communication history between the user and the individual(s) listed in the list. As discussed above, past communication history includes a past communication pattern between the user of client 101 and the individual(s) listed in the list. For example, the communications, such as e-mails, instant messages, phone calls, business meetings, etc., between the user and individual in question will be analyzed. For example, calendar agent 104 determines the last time the user and the individual in question had lunch together. In another example, calendar agent 104 determines that the user and the individual in question meet every Wednesday after work to go work-out at the gym. In one embodiment, the past communication history between the user and designated individual(s) is based on the received rules. For example, if the rules specify that calendar agent 104 is to first attempt to schedule a meeting with the highest rated person (e.g., person 1 assigned with the highest priority), then calendar agent 104 may at first only search the past communication between the user and person 1. In another example, the rules may specify to review the past communication history between the user and all the individuals listed in the list.

In step 305, calendar agent 104 searches the calendar application for the individual(s) listed in the list for scheduling information, such as whether they have that time (the time of the meeting requested by the user) free on their schedule, “presence information,” relating to the physical location of the individuals, such as whether they are working from home, whether they have that time blocked off and so forth. Such scheduling information may be used to determine if there is a scheduling conflict or whether it would be feasible to schedule a meeting with such an individual. For example, if the person is working from home which is located an hour away from the office and the user, who is at work, would like to schedule a last minute meeting, then it would not be feasible to schedule a meeting with this person. It is noted that “presence” information may be obtained for both individuals listed in the list as well as for the user who requests to schedule a meeting from the calendar applications on their computing devices. In another example, it may be inferred from the scheduling information by calendar agent 104 that the individual in question always has his/her time blocked off during the requested period of time (i.e., the time the user has selected to schedule a meeting) even though he/she may not have plans so that he/she may still possibly be available to attend a meeting with the user at the requested period of time. In another example, it may be inferred from the scheduling information by calendar agent 104 whether the individual in question has a specific meeting set during the requested period of time that he/she always attends or sometimes attends. Such information may be used in deciding whether to schedule a meeting with the individual.

In step 306, calendar agent 104 analyzes the past communication history (obtained in step 304), calendar information (obtained in step 305) and user's rules (obtained in step 303) with respect to the individuals listed in the list as discussed above.

In step 307, calendar agent 104 selects an individual from the list to have a meeting with the user based on the analysis of step 306. The person selected by calendar agent 104 to have a meeting with the user is deemed to be the one who is the best candidate for meeting with the user. Furthermore, the person selected by calendar agent 104 is also deemed to have a high probability of attending the meeting with the user. There may, however, be situations where the selected individual cannot attend the meeting or does not respond to a meeting invitation within a particular period of time. Such situations are handled as discussed further below.

In step 308, calendar agent 104 issues a meeting invitation to the selected individual. In one embodiment, client calendar agent 104 (e.g., client calendar agent 104A) sends the meeting invitation to calendar management agent 105 which distributes the meeting invitation to the selected individual of client 101 (e.g., client calendar agent 104B).

Referring to FIG. 3B, in conjunction with FIGS. 1-2, in step 309, a determination is made by calendar agent 104 as to whether the individual accepted the meeting invitation within a threshold period of time.

If the individual accepted the meeting invitation within a threshold period of time (e.g., two (2) minutes), then, in step 310, calendar agent 104 schedules a meeting with the individual which appears on the user's calendar application.

If, however, the individual did not accept the meeting invitation within a threshold period of time (e.g., declined to accept the meeting invitation, failed to respond), then, in step 311, calendar agent 104 analyzes the past communication history, calendar information and user's rules with respect to the other individual(s) listed in the list.

In step 312, calendar agent 104 selects another individual from the list to have a meeting with the user based on the analysis of step 311.

In step 313, calendar agent 104 issues a meeting invitation to the selected individual. In one embodiment, client calendar agent 104 (e.g., client calendar agent 104A) sends the meeting invitation to calendar management agent 105 which distributes the meeting invitation to the selected individual of client 101 (e.g., client calendar agent 104C). A determination is then made by calendar agent 104 as to whether the individual accepted the meeting invitation within a threshold period of time in step 309.

In some implementations, method 300 may include other and/or additional steps that, for clarity, are not depicted. Further, in some implementations, method 300 may be executed in a different order presented and that the order presented in the discussion of FIGS. 3A-3B is illustrative. Additionally, in some implementations, certain steps in method 300 may be executed in a substantially simultaneous manner or may be omitted.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for scheduling a meeting with one or more best candidates, the method comprising:
receiving a request from a user to schedule a meeting during a selected period of time;
receiving a list of individuals;
receiving rules concerning scheduling said meeting;
searching a past communication history between said user and one or more persons from said list of individuals;
searching a calendar application for said one or more persons listed in said list of individuals to obtain scheduling information;
analyzing said past communication history, said calendar information and said rules; and
issuing, by a processor, a first meeting invitation to a first person from said one or more persons listed in said list of individuals to participate in said meeting with said user during said selected period of time based on said analysis.

2. The method as recited in claim 1 further comprising:
scheduling said meeting with said first person in response to said first person accepting said first meeting invitation within a threshold period of time.

3. The method as recited in claim 1 further comprising:
issuing a second meeting invitation to a second person listed in said list of individuals based on said analysis of said past communication history, said calendar information and said rules with respect to one or more other individuals listed in said list of individuals besides said first person in response to said first person not accepting said first meeting invitation within said threshold period of time.

4. The method as recited in claim 1, wherein one or more of said individuals listed in said list are assigned a priority in meeting with said user.

5. The method as recited in claim 4 further comprising:
modifying said priority assigned to one or more of said one or more individuals listed in said list of individuals based on a past communication history between said user and said one or more of said one or more individuals listed in said list of individuals.

6. The method as recited in claim 1 further comprising:
suggesting individuals to be added to said list of individuals based on a past communication history between said user and said individuals suggested to be added to said list of individuals.

7. The method as recited in claim 1 further comprising:
populating said list of individuals based on a past communication history between said user and individuals listed in said list of individuals.

8. A computer program product embodied in a computer readable storage medium for scheduling a meeting with one or more best candidates, the computer program product comprising the programming instructions for:
receiving a request from a user to schedule a meeting during a selected period of time;
receiving a list of individuals;
receiving rules concerning scheduling said meeting;
searching a past communication history between said user and one or more persons from said list of individuals;
searching a calendar application for said one or more persons listed in said list of individuals to obtain scheduling information;
analyzing said past communication history, said calendar information and said rules; and
issuing a first meeting invitation to a first person from said one or more persons listed in said list of individuals to participate in said meeting with said user during said selected period of time based on said analysis.

9. The computer program product as recited in claim 8 further comprising the programming instructions for:
scheduling said meeting with said first person in response to said first person accepting said first meeting invitation within a threshold period of time.

10. The computer program product as recited in claim 8 further comprising the programming instructions for:
issuing a second meeting invitation to a second person listed in said list of individuals based on said analysis of said past communication history, said calendar information and said rules with respect to one or more other individuals listed in said list of individuals besides said first person in response to said first person not accepting said first meeting invitation within said threshold period of time.

11. The computer program product as recited in claim 8, wherein one or more of said individuals listed in said list are assigned a priority in meeting with said user.

12. The computer program product as recited in claim 11 further comprising the programming instructions for:
modifying said priority assigned to one or more of said one or more individuals listed in said list of individuals based on a past communication history between said user and said one or more of said one or more individuals listed in said list of individuals.

13. The computer program product as recited in claim 8 further comprising the programming instructions for:
suggesting individuals to be added to said list of individuals based on a past communication history between said user and said individuals suggested to be added to said list of individuals.

14. The computer program product as recited in claim 8 further comprising the programming instructions for:
populating said list of individuals based on a past communication history between said user and individuals listed in said list of individuals.

15. A system, comprising:
a memory unit for storing a computer program for scheduling a meeting with one or more best candidates; and
a processor coupled to said memory unit, wherein said processor, responsive to said computer program, comprises:
circuitry for receiving a request from a user to schedule a meeting during a selected period of time;
circuitry for receiving a list of individuals;
circuitry for receiving rules concerning scheduling said meeting;
circuitry for searching a past communication history between said user and one or more persons from said list of individuals;
circuitry for searching a calendar application for said one or more persons listed in said list of individuals to obtain scheduling information;
circuitry for analyzing said past communication history, said calendar information and said rules; and
circuitry for issuing a first meeting invitation to a first person from said one or more persons listed in said list of individuals to participate in said meeting with said user during said selected period of time based on said analysis.

16. The system as recited in claim 15, wherein said processor further comprises:
circuitry for scheduling said meeting with said first person in response to said first person accepting said first meeting invitation within a threshold period of time.

17. The system as recited in claim 15, wherein said processor further comprises:
circuitry for issuing a second meeting invitation to a second person listed in said list of individuals based on said analysis of said past communication history, said calendar information and said rules with respect to one or more other individuals listed in said list of individuals besides said first person in response to said first person not accepting said first meeting invitation within said threshold period of time.

18. The system as recited in claim 15, wherein one or more of said individuals listed in said list are assigned a priority in meeting with said user.

19. The system as recited in claim 18, wherein said processor further comprises:
circuitry for modifying said priority assigned to one or more of said one or more individuals listed in said list of individuals based on a past communication history between said user and said one or more of said one or more individuals listed in said list of individuals.

20. The system as recited in claim 15, wherein said processor further comprises:
circuitry for suggesting individuals to be added to said list of individuals based on a past communication history between said user and said individuals suggested to be added to said list of individuals.
